(19) United States
(12) Patent Application Publication
(10) Pub. No.: US 2012/0002855 A1
(43) Pub. Date: Jan. 5, 2012

(54) STENT LOCALIZATION IN 3D CARDIAC IMAGES

(75) Inventor: Ying BAI, Sunnyvale, CA (US)

(73) Assignee: FUJIFILM Corporation, Minato-ku (JP)

(21) Appl. No.: 12/827,433

(22) Filed: Jun. 30, 2010

(51) Int. Cl. G06T 7/00

(52) U.S. Cl. 382/131

(57) ABSTRACT

Systems and methods are described for automatically identifying coronary stents within a 3D cardiac image. Based on feature analysis on a cardiac image, coronary stents can be detected by filtering the cardiac images for stent candidates, applying a score based on factors related to coronary stents and applying a threshold. Once coronary stents are identified, in-stent restenosis and stent fractures can be further detected.

### BACKGROUND

1. Field of the Invention

This invention relates in general to methods and systems for providing stent detection and, more particularly, to providing cardiac stent detection from 3D cardiac images.

2. Description of the Related Art

A coronary stent typically is a small wire mesh tube that is used to help keep coronary (heart) arteries open after angioplasty. A catheter with an empty balloon on its tip is guided into the narrowed part of the artery. The balloon is then filled with air to flatten the plaque against the artery wall. Once the artery is open, a second balloon catheter with a stent on its tip is inserted into the artery and inflated, locking the stent into place. The diameters of coronary stents typically vary in the range of 3.0-4.0 mm.

Stent implantation has become the predominant therapy in the treatment of coronary artery diseases. A subset of treated patients experience recurrent chest pain possibly caused by in-stent restenosis, in which case, frequent evaluation of the implanted stents is required. Computed tomography (CT) has emerged as a diagnostic alternative to invasive coronary angiography for assessment of coronary artery disease. Current evaluation of coronary stents and detection of in-stent restenosis are performed through visual assessment by observers using multislice/multidetector computed tomography (MDCT). However, human interpretation of MDCT is neither efficient nor repeatable.

Therefore, there is a need for systems and methods that automate the detection of cardiac stents as well as in-stent restenosis.

### SUMMARY

In one aspect of the present invention there is provided a system for automatically identifying and analyzing coronary stents. The system may include a processor processing a cardiac image identifying regions of interest, the processor extracting the regions of interest from the cardiac image; a feature analysis unit analyzing the regions of interest for coronary stent candidates and analyzing features of the coronary stent candidates; an identifying unit automatically locating and identifying the coronary stents based on the analyzing; and a display for displaying the identified coronary stents.

Additional aspects of the present invention include a computer-implemented method for detecting a coronary stent in an image. The method may include utilizing a processor to process the image to identify regions of interest; filtering the regions of interest for automatically detecting coronary stent candidates; analyzing features of the detected coronary stent candidates; assigning a score to each of the coronary stent candidates based on the analyzed features; and for each of the coronary stent candidates, comparing the assigned score to a threshold. If the assigned score exceeds the threshold, the method may further include identifying the coronary stent candidate as a coronary stent; and displaying the indication that the coronary stent candidate is a coronary stent.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates a flowchart of an embodiment of a method for using a stent detection system according to an embodiment of the present invention,

FIGS. 2(a)-2(c) illustrate examples of feature analysis performed according to an embodiment of the invention.

FIG. 3 is an image showing an example of a coronary stent with restenosis.

FIG. 4 is an image illustrating an example of a coronary stent with stent fractures.

FIG. 5 shows an example output of a stent identified by the system in accordance to an embodiment of the invention.

FIG. 6 is a functional diagram of an embodiment of the invention.

FIG. 7 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or a combination of software and hardware.

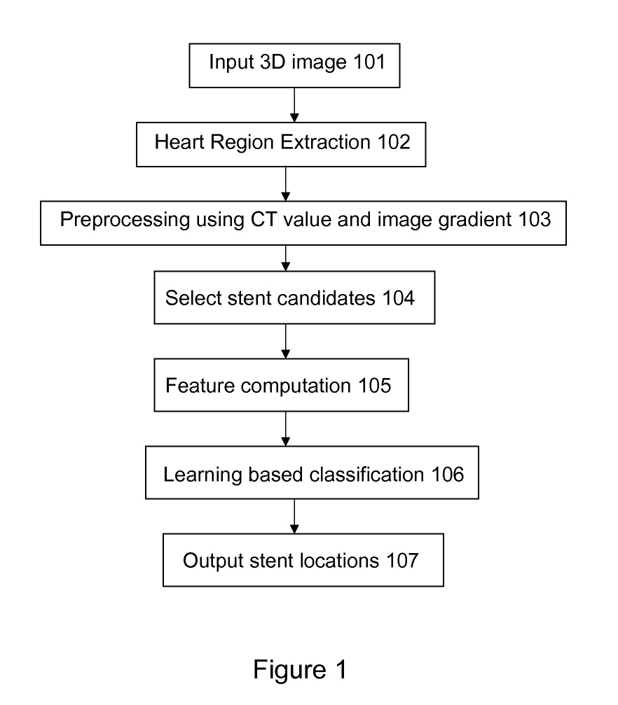

FIG. 1 illustrates a flowchart of a method according to embodiment of the invention using a stent detection system. 3D images 101, such as cardiac CT data are input into the system. The heart region is extracted from those images 102 to constrain the search range to that heart region for the cardiac stent candidates. Because stents usually appear as bright structures due to their metallic composition, thresholding is applied 103 using the CT value and image gradient information to preprocess the image to locate regions of interest. The size of a coronary stent is roughly known a priori, thus, noise and other large bright structures can be filtered out based on the region size information, leaving remaining candidates that are selected for further processing 104. For the remaining selected candidates, a set of distinctive features (including distribution, size, location, shape, etc.) are computed 105 and input into a learning based classifier 106 to filter out false positives with a classification step. Finally, the system outputs the calculated stent locations 107. The learning based classifier can also adjust the threshold and gradient values as needed to reduce errors in classification.

Feature Analysis

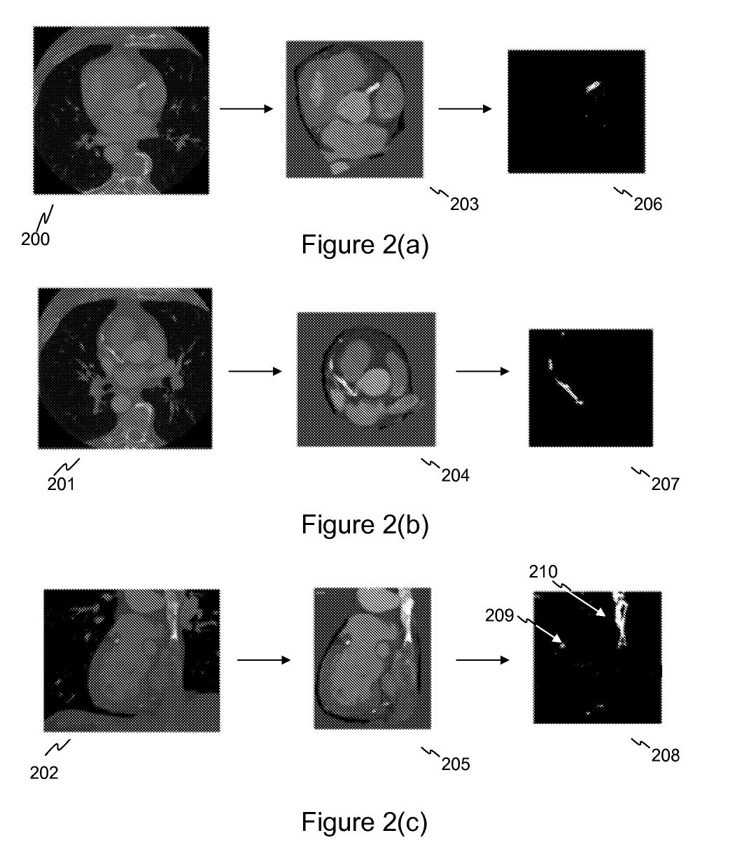

During the feature analysis process, the system can analyze various features to distinguish a cardiac stent from objects that appear similar to stents, such as calcium deposits. FIGS. 2(a)-2(c) illustrate examples of feature analysis of three different sets of 3D images as performed by the system according to an embodiment of the invention. Upon receiving the 3D images 200, 201, 202, the system processes those images and extracts an image of a region of interest (i.e. some part of the heart region) 203, 204, 205. The heart region can be extracted, for example, by a heart extraction engine which crops data images to a smaller volume which contains the heart. Subsequently, the feature analysis begins searching the region of interest for potential stent candidates. The feature analysis may involve assigning scores to each of the potential stent candidates based on the brightness intensity of the candidate, although other factors such as the size, the shape, the location of the stent candidate (particularly in regards to landmarks within the cardiac image), voxel comparison etc., may also be used. The feature analysis can also utilize a database of cardiac images with labeled cardiac stents to attempt template matching in determining the score.

Brightness: In the example provided by the figure, the system can apply thresholding based on the scores to the data to constrain detection to a few locations. For example, after applying thresholding based on brightness intensity, the white areas that still remain in the preprocessed data (see 206, 207 and 208) are: coronary stents 206 from the set in FIG. 2(a), calcium 207 from the set in FIG. 2(b), and the righter upper lobe pulmonary vein 210 in which contrast agent has been injected 208 from the set in FIG. 2(c). These areas remain due to their scores meeting the threshold requirements.

Location: Landmarks within the heart region (veins, arteries, coronary walls, etc.) can also be used to indicate the probability that a particular stent candidate has of being a stent, based on distances from such locations or their orientation in comparison to those landmarks. In an embodiment of the invention, the apex of the left ventricle, the aortic valve, and the mitral valve are used as key landmarks within the heart. They are examples of distinctive points that can be automatically and robustly detected from each set of data. Since coronary stents are normally located in coronary arteries surrounding the heart region, the distance and orientation to these landmark points therefore fall into a certain range.

Size: Because the size of a coronary stent is known to be quite small, the method can operate with this a priori knowledge so that the system can thereby remove the pulmonary vein from the image by applying, for example, a regional connected component analysis, by calculating the size of connected components inside the thresholded CT volume and discard those large blobs. For size computations, stents typically take up an area of three hundred to five thousand voxels. For example, in identifying the stent 209 from the pulmonary vein 210, the system can thereby eliminate the pulmonary vein as a potential stent candidate based on the size being too large, even though the pulmonary vein may meet the threshold requirements of other factors

Shape: To further filter out the calcium, the system can utilize other factors and apply further thresholding. The results can subsequently be output to the system user. One example of such factors is the shape of the stent candidate. Stents tend to have a tubular shape, so candidates that are closer to the expected tubular shape may be given a high score than the candidates that don't have the tubular shape. Changes in the gradient area are also analyzed based on the size of the stent candidate. Because stents tend to have a rather small radius, gradients larger than a certain threshold should be analyzed for other factors to ensure correct classification.

Learning Based Classification

In a further embodiment of the system, learning based classification can be used to adjust the threshold and the scoring system of the factors used. The learning based classification can utilize a database of previously classified images as a reference. Based on the database of images, the scoring system, factors, and threshold can be adjusted to reduce the probability of false positives. Furthermore, images classified by the system can also be added to the database, so that if false positives are detected, the images can be reclassified manually to ensure that the system has a smaller error rate. Thus, training data is thereby used to build a classifying system that utilizes such learning based classifiers that are known in the art. Examples of such classifiers include support vector machines, neural networks, and Gaussian mixture models. However, any learning based classifiers can be incorporated into the system.

Application to In-Stent Restenosis (ISR) Detection

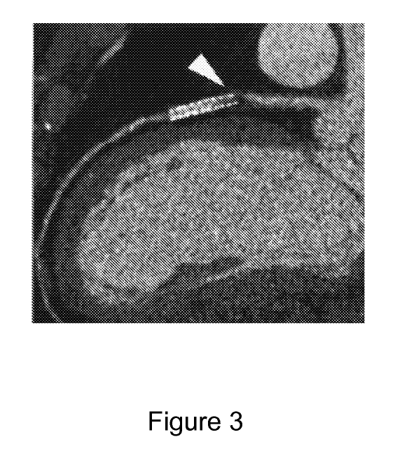

FIG. 3 illustrates an example of a coronary stent with restenosis. The clinical incidence of restenosis after coronary stent implantation is about 20-35% for bare metal stents and 5-10% for drug-eluting stents. In a multislice computed tomography (MSCT), in-stent restenosis (ISR) is indicated by the presence of a large obstructing hypodense lesion in the proximal part of the stent, as shown by the arrow in FIG. 3. Given the high number of patients who receive stent implantation, a non-invasive automated tool for reliable detection of in-stent restenosis would be clinically useful. An embodiment of the inventive system can identify in-stent restenosis for detected stents. The system can be configured to detect factors indicative of in-stent restenosis (such as detecting lesions within the stent) and thresholding can also be applied.

For example, when the system detects the stents, one method to detect ISR can be to analyze, from one end of the stent to the other end, any dark regions occurring within the detected stent. Because the stent should have a relatively high brightness in contrast to regions affected by ISR, dark regions located within the stent can thus be considered candidates for ISR. By utilizing this method within a learning based system thresholds can be derived to determine the difference between a dark region indicating ISR and that indicating, for example, the walls of an artery.

Application to Stent Fracture (SF) Detection

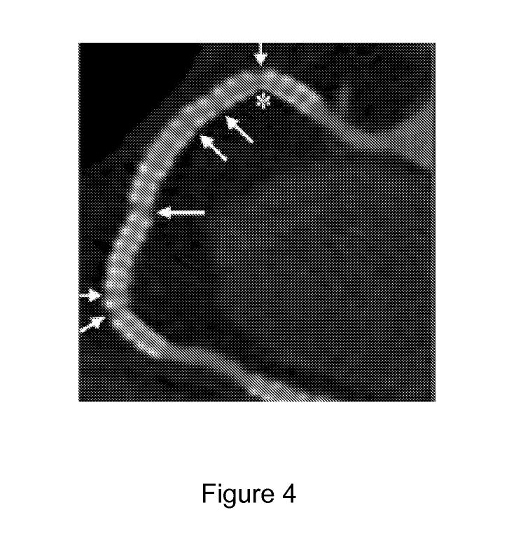

FIG. 4 illustrates an example of a coronary stent with stent fractures (SF). SF is one of the leading risk factors of thrombosis and in-stent restenosis in patients who have intra-coronary drug-eluting stent implants. The state-of-the-art diagnosis of SF is to have radiologists examine coronary computed tomography angiography (CTA) and look for complete separation, misalignment, or partial separation of the stent struts. The example shown in FIG. 4 contains multiple fractures, which are indicated by arrows. Once coronary stents are located certain embodiments of the inventive system can be configured to identify in stent fractures as well as identifying the stent. The aforementioned factors can be adjusted as needed to locate fractures within a given stent.

For example, once a stent is detected, cross sections of the stent can be analyzed, for example, for thinning of the tube shape of the stent or any discontinuity that would be indicative of a stent fracture. If the radius of the tube becomes smaller in one region of the stent, the learning based system may classify the region as a potential stent fracture.

Output Of Stent Locations

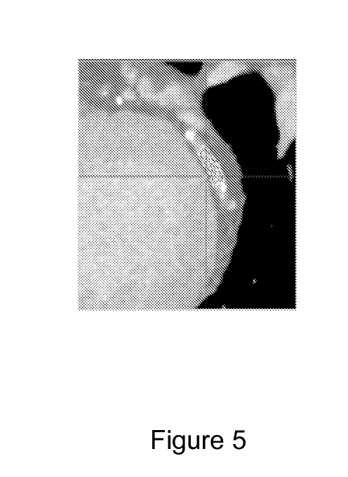

Once the stent candidates have been filtered based on the aforementioned factors, the system can then output the calculated stent locations. FIG. 5 shows an example output of a stent identified by the system. Once a stent has been identified, borders or highlighting can be used to indicate the location of the stent. Crosshairs may also be used to further aid the user in the location of the stent. Other indication means may also be used, such as arrows as indicated in FIG. 2, highlighting, or creating a mask on each of the located stents.

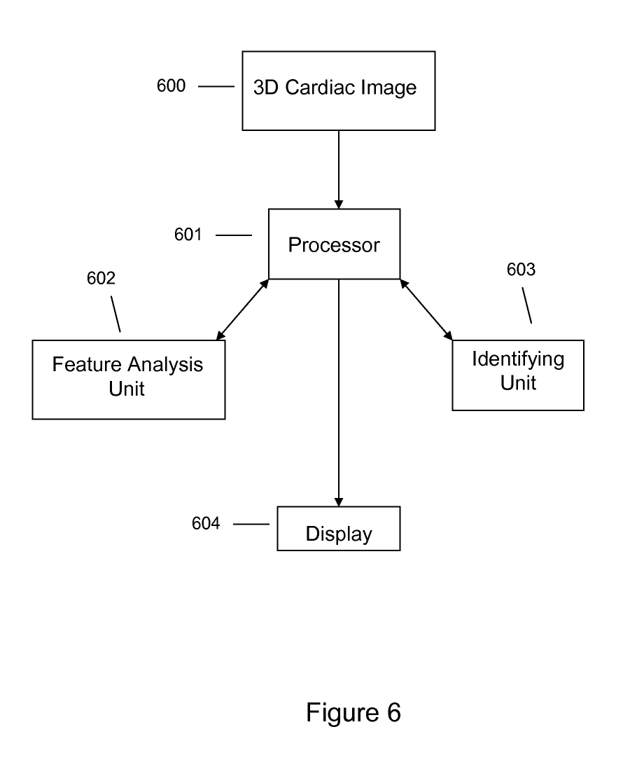

FIG. 6 illustrates an example functional diagram for an embodiment of a system embodying the invention. A 3D cardiac image 600 is received and input into the system. The input image is processed by the processor 601 according to the algorithms discussed above. The processor processes the 3D cardiac image to detect regions of interest, and then extracts those regions of interest. A feature analysis unit 602 analyzes the regions of interest for potential coronary stent candidates and also analyzes features of the potential coronary stent candidates. The feature analysis unit may then assign a score to each of the potential coronary stent candidates. Subsequently an identifying unit 603 can locate and identify the coronary stents based on comparing assigned scores to a threshold. Once the identifying unit identifies the coronary stents, the stent locations can be displayed onto a display 604.

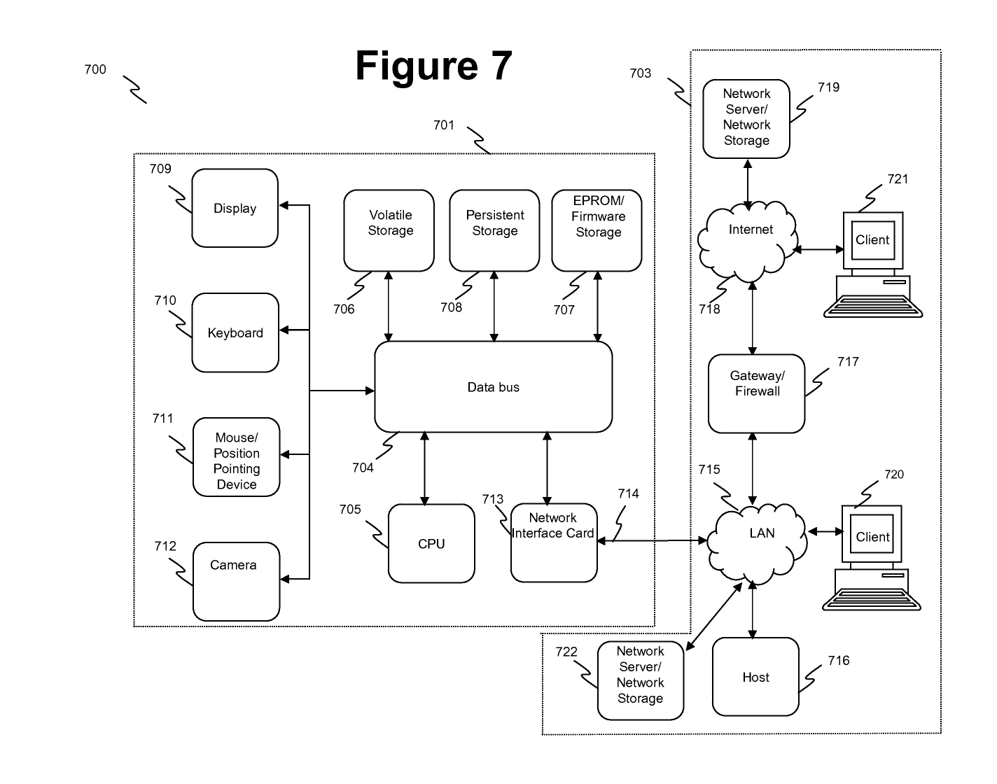

FIG. 7 illustrates an exemplary embodiment of a computer platform upon which the inventive system may be implemented.

FIG. 7 is a block diagram that illustrates an embodiment of a computer/server system 700 upon which an embodiment of the inventive methodology may be implemented. The system 700 includes a computer/server platform 701, peripheral devices 702 and network resources 703.

The computer platform 701 may include a data bus 705 or other communication mechanism for communicating information across and among various parts of the computer platform 701, and a processor 705 coupled with bus 701 for processing information and performing other computational and control tasks. Computer platform 701 also includes a volatile storage 706, such as a random access memory (RAM) or other dynamic storage device, coupled to bus 705 for storing various information as well as instructions to be executed by processor 705. The volatile storage 706 also may be used for storing temporary variables or other intermediate information during execution of instructions by processor 705. Computer platform 701 may further include a read only memory (ROM or EPROM) 707 or other static storage device coupled to bus 705 for storing static information and instructions for processor 705, such as basic input-output system (BIOS), as well as various system configuration parameters. A persistent storage device 708, such as a magnetic disk, optical disk, or solid-state flash memory device is provided and coupled to bus 701 for storing information and instructions.

Computer platform 701 may be coupled via bus 705 to a display 709, such as a cathode ray tube (CRT), plasma display, or a liquid crystal display (LCD), for displaying information to a system administrator or user of the computer platform 701. An input device 710, including alphanumeric and other keys, is coupled to bus 701 for communicating information and command selections to processor 705. Another type of user input device is cursor control device 711, such as a mouse, a trackball, or cursor direction keys for communicating direction information and command selections to processor 705 and for controlling cursor movement on display 709. This input device typically has two degrees of freedom in two axes, a first axis (e.g., x) and a second axis (e.g., y), that allows the device to specify positions in a plane.

An external storage device 712 may be coupled to the computer platform 701 via bus 705 to provide an extra or removable storage capacity for the computer platform 701. In an embodiment of the computer system 700, the external removable storage device 712 may be used to facilitate exchange of data with other computer systems.

The invention is related to the use of computer system 700 for implementing the techniques described herein. In an embodiment, the inventive system may reside on a machine such as computer platform 701. According to one embodiment of the invention, the techniques described herein are performed by computer system 700 in response to processor 705 executing one or more sequences of one or more instructions contained in the volatile memory 706. Such instructions may be read into volatile memory 706 from another computer-readable medium, such as persistent storage device 708. Execution of the sequences of instructions contained in the volatile memory 706 causes processor 705 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 705 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 708. Volatile media includes dynamic memory, such as volatile storage 706.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 705 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 705. The bus 705 carries the data to the volatile storage 706, from which processor 705 retrieves and executes the instructions. The instructions received by the volatile memory 706 may optionally be stored on persistent storage device 708 either before or after execution by processor 705. The instructions may also be downloaded into the computer platform 701 via Internet using a variety of network data communication protocols well known in the art.

The computer platform 701 also includes a communication interface, such as network interface card 713 coupled to the data bus 705. Communication interface 713 provides a two-way data communication coupling to a network link 715 that is coupled to a local network 715. For example, communication interface 713 may be an integrated services digital network (ISDN) card or a modem to provide a data communication connection to a corresponding type of telephone line. As another example, communication interface 713 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 713 sends and receives electrical, electromagnetic or optical signals that carry digital data streams representing various types of information.

Network link 713 typically provides data communication through one or more networks to other network resources. For example, network link 715 may provide a connection through local network 715 to a host computer 716, or a network storage/server 717. Additionally or alternatively, the network link 713 may connect through gateway/firewall 717 to the wide-area or global network 718, such as an Internet. Thus, the computer platform 701 can access network resources located anywhere on the Internet 718, such as a remote network storage/server 719. On the other hand, the computer platform 701 may also be accessed by clients located anywhere on the local area network 715 and/or the Internet 718. The network clients 720 and 721 may themselves be implemented based on the computer platform similar to the platform 701.

Local network 715 and the Internet 718 both use electrical, electromagnetic or optical signals that carry digital data streams. The signals through the various networks and the signals on network link 715 and through communication interface 713, which carry the digital data to and from computer platform 701, are exemplary forms of carrier waves transporting the information.

Computer platform 701 can send messages and receive data, including program code, through the variety of network(s) including Internet 718 and LAN 715, network link 715 and communication interface 713. In the Internet example, when the system 701 acts as a network server, it might transmit a requested code or data for an application program running on client(s) 720 and/or 721 through Internet 718, gateway/firewall 717, local area network 715 and communication interface 713. Similarly, it may receive code from other network resources.

The received code may be executed by processor 705 as it is received, and/or stored in persistent or volatile storage devices 708 and 706, respectively, or other non-volatile storage for later execution.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the system for stent localization in 3D cardiac images. It is intended that the specification and examples be considered as exemplary only, with a true scope and spirit of the invention being indicated by the following claims.

What is claimed is:

1. A system for automatically identifying and analyzing coronary stents, the system comprising:
a processor processing a cardiac image identifying regions of interest, the processor extracting the regions of interest from the cardiac image;
a feature analysis unit analyzing the regions of interest for coronary stent candidates and analyzing features of the coronary stent candidates;
an identifying unit automatically locating and identifying the coronary stents based on the analyzing; and
a display for displaying the identified coronary stents.

2. The system of claim 1, wherein the feature analysis unit assigns a score based on comparing a location of the potential stent candidate to a landmark within the 3D cardiac image.

3. The system of claim 1, wherein the feature analysis unit assigns a score based on the shape of the potential stent candidate.

4. The system of claim 1, wherein the feature analysis unit assigns a score based on the size of the potential stent candidate.

5. The system of claim 1, further comprising a database of classified images of coronary stents.

6. The system of claim 5, wherein the feature analysis unit further compares regions of interest with the classified images in the database, and adjusts the assigned score based on the comparison.

7. The system of claim 1, wherein the identifying unit further determines in-stent restenosis based on the identified coronary stents.

8. The system of claim 1, wherein the identifying unit further determines stent fractures within identified coronary stents.

9. The system of claim 1, wherein the 3D cardiac image is a 3D ultrasound image.

10. The system of claim 1, wherein the 3D cardiac image is a CT image.

11. The system of claim 1, wherein the 3D cardiac image is a MR image.

12. A computer-implemented method for detecting a coronary stent in an image, the method comprising:
utilizing a processor to process the image to identify regions of interest;
filtering the regions of interest for automatically detecting coronary stent candidates;
analyzing features of the detected coronary stent candidates;
assigning a score to each of the coronary stent candidates based on the analyzed features;
for each of the coronary stent candidates, comparing the assigned score to a threshold;
if the assigned score exceeds the threshold, identifying the coronary stent candidate as a coronary stent; and
displaying the indication that the coronary stent candidate is a coronary stent.

13. The computer implemented method of claim 12, wherein the analyzing further comprises comparing a location of the potential stent candidate to a landmark within the 3D cardiac image.

14. The computer implemented method of claim 12, wherein the analyzing further comprises analyzing the shape of the potential stent candidate.

15. The computer implemented method of 12, wherein the analyzing further comprises analyzing the size of the potential stent candidate.

16. The computer implemented method of claim 12, wherein the analyzing further comprises comparing regions of interest with the classified images in the database.

17. The computer implemented method of claim 12, further comprising determining in-stent restenosis based on the identified coronary stents.

18. The computer implemented method of claim 12, further comprising determining stent fractures within identified coronary stents.

19. The computer implemented method of claim 12, wherein the 3D cardiac image is one of a 3D ultrasound image, a CT image, and a MR image.

20. The computer implemented method of claim 12, wherein the steps of filtering the regions of interest, analyzing features, assigning a score and identifying stent candidates as coronary stents, are performed automatically.
